(19) United States
(12) Patent Application Publication
(10) Pub. No.: US 2005/0190824 A1
(43) Pub. Date: Sep. 1, 2005

(54) Method and apparatus for mounting a modem to a carrier assembly

(76) Inventors: Brad L. Grande, Marlboro, NJ (US); Rodney Mehrlander, Oceanport, NJ (US)

Correspondence Address: Ryan, Mason & Lewis, LLP, Suite 205, 1300 Post Road, Fairfield, CT, 06824, US

(21) Appl. No.: 10/787,380

(22) Filed: Feb. 26, 2004

(51) Int. Cl. H04B 1/38

(52) U.S. Cl. 375/222

(57) ABSTRACT

A method and apparatus are disclosed for connecting a modem to a motherboard in a computing device, such as a personal computer. The disclosed modem module comprises circuitry for interfacing with a telephone line; and one or more solder pads for connecting the modem module to a carrier assembly, such as a motherboard. The solder pads on the modem module may be soldered to corresponding solder pads on the carrier assembly. The modem module optionally includes a tip/ring connector for interfacing with a telephone line. A disclosed method for fabricating a discrete modem upon a printed circuit board (PCB) or other stand-alone mounting comprises the steps of providing circuitry on a printed circuit board for interfacing with a telephone line; and providing one or more solder pads on the printed circuit board for connecting the modem module to a carrier assembly.

### FIELD OF THE INVENTION

The present invention relates generally to modems and, more particularly, to techniques for connecting a modem to a motherboard in a computing device, such as a personal computer.

### BACKGROUND OF THE INVENTION

Computing devices typically include a modem to allow the computing device to communicate digital information over an analog telephone line. Increasingly, manufacturers of computing devices, such as personal desktop computers and laptops, are integrating the modem into the motherboard of the computing device. A motherboard is the main circuit board within a computing device, typically bearing the primary components of the device, including a processor, memory, bus controller and bus connector. Among other benefits, the integration of the modem onto the motherboard reduces component and manufacturing costs.

Many countries or regions require certification of certain classes of electronic devices, including modems and motherboards, to ensure that the devices comply with applicable rules and regulations, including emission limits for various frequency bands. The applicable rules and regulations typically vary from region to region, and the process of certifying a given device internationally is often costly, complex and burdensome. In the United States, Europe and Japan, for example, the appropriate regulatory bodies are the Federal Communications Commission (FCC), the European Conference of Postal and Telecommunications Administrations (CEPT) and the Ministry of Posts and Telecommunications (MPT), respectively. When a new modem design is integrated into an existing motherboard design, the entire motherboard must be certified with the appropriate regulatory bodies in each desired country or region, thereby significantly increasing the scope and costs of the certification process.

In order to limit the scope of the certification process to the modem itself, a number of manufacturers have introduced self-contained modem assemblies that are connected to the motherboard using a connector assembly. The connector assemblies add manufacturing costs to the modem assembly and the motherboard, and also implicate reliability and surface area issues. A need therefore exists for an improved modem design that allows the modem to be certified as a stand-alone device, and then integrated onto a PC motherboard without requiring the entire motherboard to be recertified.

### SUMMARY OF THE INVENTION

Generally, a method and apparatus are provided for connecting a modem to a motherboard in a computing device, such as a personal computer. The disclosed modem module comprises circuitry for interfacing with a telephone line; and one or more solder pads for connecting the modem module to a carrier assembly, such as a motherboard. The solder pads on the modem module may be soldered to corresponding solder pads on the carrier assembly. The modem module optionally includes a tip/ring connector for interfacing with a telephone line.

A method is also disclosed for fabricating a discrete modem upon a printed circuit board (PCB) or other stand-alone mounting. The fabrication method comprises the steps of providing circuitry on a printed circuit board for interfacing with a telephone line; and providing one or more solder pads on the printed circuit board for connecting the modem module to a carrier assembly.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram illustrating the connection of a modem assembly to a motherboard in accordance with the present invention;

FIG. 2 is an image illustrating a modem assembly incorporating features of the present invention and a carrier upon which the modem assembly will be attached; and

FIG. 3 is an image illustrating the modem assembly of FIG. 3 soldered to the carrier in accordance with the present invention.

### DETAILED DESCRIPTION

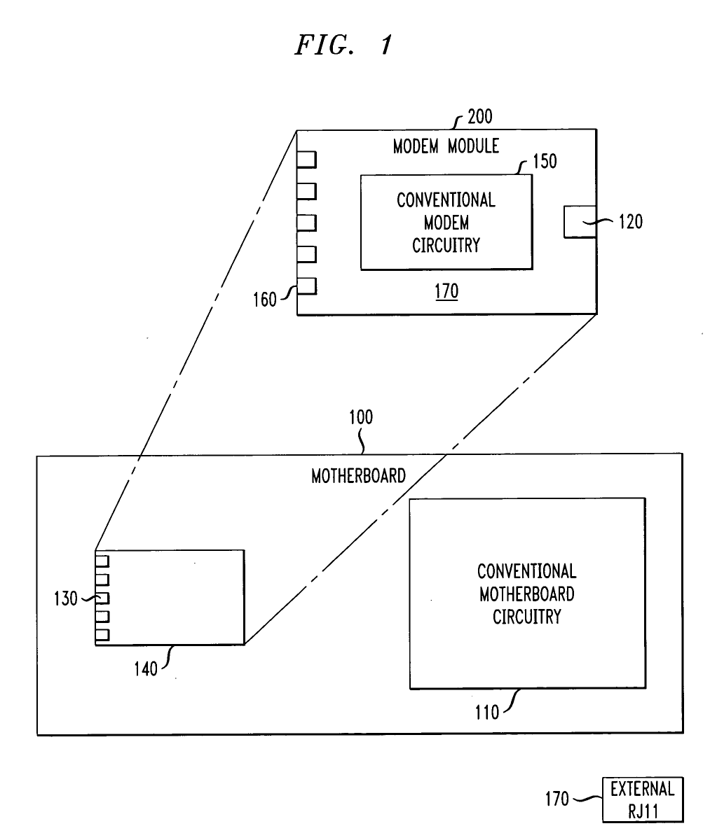

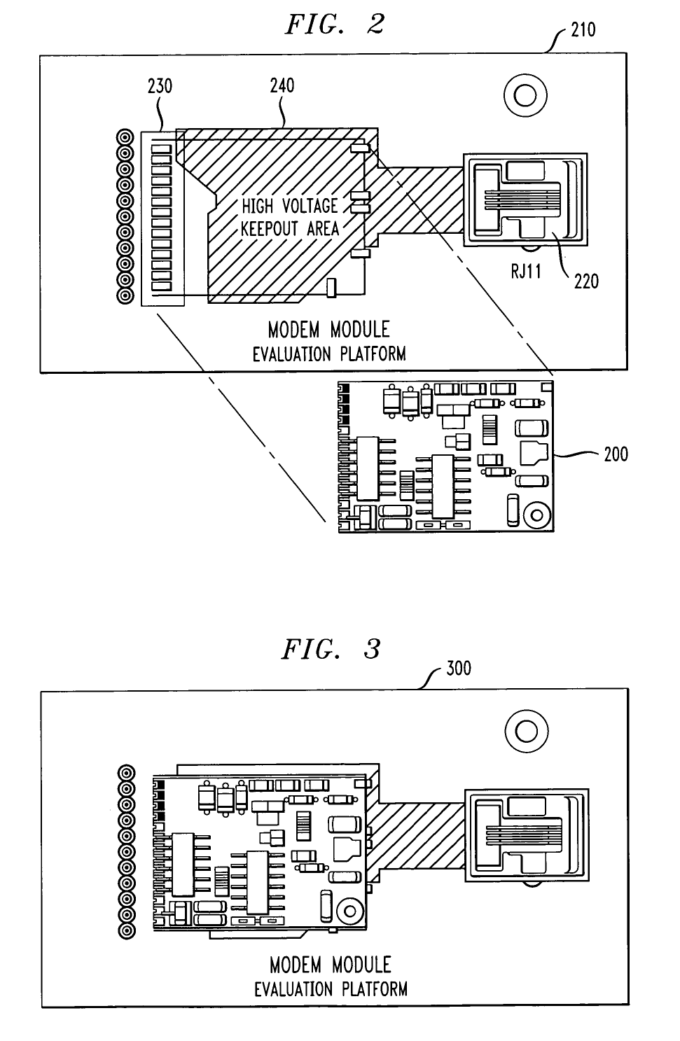

FIG. 1 is a schematic block diagram illustrating the connection of a modem assembly 200, discussed further below in conjunction with FIG. 2, to a motherboard 100 in accordance with the present invention. The modem assembly 200 may be, for example, a soft modem used in computing device, such as a laptop, where the signals are processed by a host processor. The motherboard 100 may be associated with, for example, a computing device, a set top terminal, game device, audio/video device or a telephone. As shown in FIG. 1, the modem assembly 200 includes conventional modem circuitry 150 and the motherboard 100 includes conventional motherboard circuitry 110. For a description of typical conventional modem circuitry 150 and conventional motherboard circuitry 110, see, for example, Ron Gilster, PC Hardware: A Beginner's Guide, McGraw-Hill Osborne Media; ISBN: 0072129905 (Apr. 26, 2001); or John A. C. Bingham, The Theory and Practice of Modem Design, Wiley-Interscience, ISBN: 0471851086 (Apr. 26, 1988).

As previously indicated, the present invention provides a discrete modem 200 that may be fabricated, for example, upon a printed circuit board 170 or another stand-alone mounting. According to one aspect of the invention, the modem assembly 200 is physically attached to the motherboard 100 by soldering pad connections 160 on the modem assembly 200 to corresponding pad connections 130 on the motherboard 100. The modem assembly 200 is soldered to the motherboard 100 in a corresponding region 140 of the motherboard 100. A tip/ring connector 120 on the modem assembly 200 may then be connected to an external RJ11 connector 170. Alternatively, the tip/ring connector 120 can be provided on the motherboard 100. The tip/ring connector 120 is connected to a telephone line in a known manner.

FIG. 2 is an image illustrating the modem assembly 200 of FIG. 1 and a carrier 210 upon which the modem assembly 200 can be attached. The carrier 210 is a simplified version of the motherboard 100 of FIG. 1 for illustration purposes. The modem assembly 200 would normally be mounted on a motherboard for a computing device, such as a personal computer or laptop, as would be apparent to a person of ordinary skill in the art. As shown in FIG. 2, the carrier 210 includes solder pad connections 230 for mounting the modem assembly 200 in a region 240 of the carrier 210. In the exemplary embodiment shown in FIG. 2, the tip/ring connector 220 is part of the carrier 210.

The modem assembly 200 can be manufactured using standard PCB technologies, such as those described in Jon Varteresian, Fabricating Printed Circuit Boards, Newnes; Book and CD-ROM edition, ISBN: 1878707507 (Jun. 15, 2002). In one implementation, the soldering pad connections 160 on the modem assembly 200 can be embodied as board edge plating that is electrically connected to the electrical interfacing signals provided by the conventional modem circuitry 150. As discussed further above in conjunction with FIG. 1, the motherboard 100 contains solder pads 130 that physically align with these edge pads. Standard surface mount pick and place assembly and solder reflow processes are utilized in the mounting of the modem assembly 200 to the motherboard 100.

FIG. 3 is an image 300 illustrating the modem assembly 200 of FIG. 2 soldered to the carrier 210 (motherboard) in accordance with the present invention. As previously indicated, the modem assembly 200 is physically attached to the carrier 210 (motherboard) by soldering pad connections on the modem assembly 200 to corresponding pad connections 230 on the carrier 210. Among other benefits, the present invention utilizes standard manufacturing processes to reduce the fabrication costs and simplify the scope of regulatory certification processes and increases reliability by removing mechanical connectors.

The disclosed techniques for connecting a modem to a motherboard provide a discrete modem design that may be certified as a stand-alone device. The disclosed modems may be integrated onto a motherboard without requiring recertification of the motherboard. The certification process is simplified because the discrete modem is a smaller and less complex system than a typical full motherboard/modem combination. In addition, the disclosed modems can be certified independently of the motherboard(s) that they will ultimately be mated to. In various embodiments of the present invention, the modem board can be aligned parallel or perpendicular to the surface of the motherboard.

It is to be understood that the embodiments and variations shown and described herein are merely illustrative of the principles of this invention and that various modifications may be implemented by those skilled in the art without departing from the scope and spirit of the invention.

1. A modem module for connecting to a carrier assembly, comprising:
circuitry for interfacing with a telephone line; and
one or more solder pads for connecting said modem module to said carrier assembly.

2. The modem module of claim 1, further comprising a tip/ring connector for interfacing with said telephone line.

3. The modem module of claim 1, further comprising a connection to a tip/ring connector.

4. The modem module of claim 1, wherein said carrier assembly is a motherboard.

5. The modem module of claim 1, wherein said one or more solder pads are soldered to corresponding one or more solder pads on said carrier assembly.

6. The modem module of claim 1, wherein said modem assembly is fabricated on a printed circuit board.

7. The modem module of claim 1, wherein said modem assembly is an integrated device.

8. A method for fabricating a modem module for connection to a carrier assembly, comprising the steps of:
providing circuitry on a printed circuit board for interfacing with a telephone line; and
providing one or more solder pads on said printed circuit board for connecting said modem module to said carrier assembly.

9. The method of claim 8, further comprising the step of providing a tip/ring connector for interfacing with said telephone line.

10. The method of claim 8, further comprising the step of connecting to a tip/ring connector.

11. The method of claim 8, wherein said carrier assembly is a motherboard.

12. The method of claim 8, further comprising the step of soldering said one or more solder pads to corresponding one or more solder pads on said carrier assembly.

13. The method of claim 8, further comprising the step of fabricating said modem assembly on a printed circuit board.

14. A printed circuit board, comprising:
modem circuitry for interfacing with a telephone line; and
one or more solder pads for connecting said modem circuitry to a carrier assembly.

15. The printed circuit board of claim 14, further comprising a tip/ring connector for interfacing with said telephone line.

16. The printed circuit board of claim 14, further comprising a connection to a tip/ring connector.

17. The printed circuit board of claim 14, wherein said carrier assembly is a motherboard.

18. The printed circuit board of claim 14, wherein said one or more solder pads are soldered to corresponding one or more solder pads on said carrier assembly.

19. The printed circuit board of claim 14, wherein said modem assembly is fabricated on a printed circuit board.

20. The printed circuit board of claim 14, wherein said modem assembly is an integrated device.
